(19) United States
(12) Patent Application Publication
(10) Pub. No.: US 2026/0225659 A1
(43) Pub. Date: Aug. 6, 2026

(54) VEHICLE FRAMEWORK STRUCTURE

(71) Applicant: TOYOTA JIDOSHA KABUSHIKI KAISHA, Aichi-ken (JP)

(72) Inventors: Ayaka KAGAMI, Inazawa-shi (JP); Soshiro MURATA, Toyota-shi (JP)

(21) Appl. No.: 19/457,174

(22) Filed: Jan. 23, 2026

(30) Foreign Application Priority Data
Feb. 4, 2025 (JP) 2025-017121

(51) Int. Cl. B62D 21/15; B60K 11/04; B60R 19/24; B62D 21/11

(52) U.S. Cl. CPC B62D 21/152; B62D 21/11; B60K 11/04; B60R 19/24

(57) ABSTRACT

A vehicle framework structure including: a pair of front side member sections provided at two vehicle width direction sides; a pair of shock absorption sections respectively provided at a vehicle front side of the pair of front side member sections; a cross member section extending in the vehicle width direction and disposed between the pair of front side member sections; and a left-right pair of coupling sections each configured including a first connection section to which the shock absorption section is connected, a second connection section that is further to a vehicle rear side than the first connection section and to which the cross member section is connected, and an inclined section that is between the first connection section and the second connection section and that is inclined toward the vehicle width direction inside on progression from a vehicle forward direction toward the vehicle rearward direction.

### CROSS-REFERENCE TO RELATED APPLICATION

This application is based on and claims priority under 35 USC 119 from Japanese Patent Application No. 2025-017121 filed on Feb. 4, 2025, the disclosure of which is incorporated by reference herein.

### BACKGROUND

### Technical Field

The present disclosure relates to a vehicle framework structure.

### Related Art

A framework structure including a gusset for coupling a front side member, an apron upper member, a crash box, and a cross member together is disclosed in Japanese Patent Application Laid-Open (JP-A) No. 2020-023242.

However, load does not readily transmit to the cross member during an offset collision or during a small overlap collision with the structure described in JP-A No. 2020-023242, and there is room for improvement from the perspective of effectively distributing collision load.

### SUMMARY

An object of the present disclosure is to obtain a vehicle framework structure capable of distributing collision load effectively.

A vehicle framework structure of a first aspect includes a pair of front side member sections provided at two vehicle width direction sides and respectively extending in a vehicle front-rear direction, a pair of shock absorption sections respectively provided at a vehicle front side of the pair of front side member sections, a cross member section extending in the vehicle width direction and disposed between the pair of front side member sections, and a left-right pair of coupling sections. Each of the left-right pair of coupling sections is configured including a first connection section to which the shock absorption section is connected, a second connection section that is further to a vehicle rear side than the first connection section and to which the cross member section is connected, and an inclined section that is between the first connection section and the second connection section and that is inclined toward the vehicle width direction inside on progression from a vehicle forward direction toward the vehicle rearward direction.

In the vehicle framework structure of the first aspect, the pair of front side member sections is provided at the two vehicle width direction sides, with the front side member sections each extending in the vehicle front-rear direction. Moreover, the shock absorption sections are provided at the vehicle front side of the front side member sections. The cross member section is provided between the front side member sections, and the cross member section and the shock absorption sections are coupled together by coupling sections. This accordingly enables collision load from the shock absorption sections to be distributed to the cross member section through the coupling sections.

Moreover, each of the coupling sections is configured including the first connection section to which the shock absorption section is connected, the second connection section that is further to a vehicle rear side than the first connection section and to which the cross member section is connected, and the inclined section that is between the first connection section and the second connection section and that is inclined toward the vehicle width direction inside on progression from a vehicle forward direction toward the vehicle rearward direction. This thereby enables collision load to easily flow from the inclined section to the cross member section through the second connection section, enabling collision load to be distributed effectively. Note that reference here to “inclined” is not limited to an embodiment extending at an angle in a straight line, and has a wide definition encompassing configurations extending with a step shape or circular arc shape with a vehicle rear side thereof positioned further to the vehicle width direction inside than the vehicle front side thereof.

A vehicle framework structure of a second aspect is the first aspect, wherein the inclined section is provided to a front portion of the coupling section.

In the vehicle framework structure of the second aspect, the inclined section is formed to the front portion of the coupling section. This accordingly means that collision load can be transmitted to the inclined section more effectively than cases in which the inclined section is formed to a rear portion of the coupling section.

A vehicle framework structure of a third aspect is the first aspect, wherein the first connection section is connected to a rear end portion of the shock absorption section.

In the vehicle framework structure of the third aspect, the collision load is transmitted from the rear end portion of the shock absorption section to the coupling section via the first connection section. This thereby enables the entire area of the shock absorption section to be utilized for absorbing collision load. For example, in cases in which shock is absorbed by the shock absorption section collapsing, due to the first connection section being connected to the rear end portion of the shock absorption section, residual non-collapsed portions of the shock absorption section can be suppressed from being generated.

A vehicle framework structure of a fourth aspect is the first aspect, wherein the cross member section is disposed further to the vehicle rear side than a front end portion of the front side member section.

In the vehicle framework structure of the fourth aspect, buckling of the cross member section is suppressed compared to structures in which the cross member section is disposed in front of the front end portion of the front side member section, enabling good distribution of collision load.

A vehicle framework structure of a fifth aspect is the first aspect, wherein the coupling section is configured including a main body that extends in the vehicle width direction and the vehicle front-rear direction and that is disposed above the front side member section, and an upright wall that extends downward from a lower face of the main body and that opposes a portion on a vehicle width direction inside of the front side member section.

In the vehicle framework structure of the fifth aspect, the main body of the coupling section is disposed above the front side member section, and the upright wall of the coupling section opposes the portion on the vehicle width direction inside of the front side member section. The upright wall abuts the front side member section either directly or through another member when the shock absorption section deforms due to a collision. Due to the coupling section being retained in at least two directions by the front side member section, fracturing of the coupling section can be suppressed from occurring.

A vehicle framework structure of a sixth aspect is the fifth aspect, configured with the upright wall and the portion on the vehicle width direction inside of the front side member section fastened together.

In the vehicle framework structure of the sixth aspect, the main body of the coupling section is disposed above the front side member section, and the upright wall of the coupling section is directly or indirectly fastened to the portion on the vehicle width direction inside of the front side member section. Fracturing of the coupling section can be suppressed further due to the coupling section being fastened in this manner.

A vehicle framework structure of a seventh aspect is the fifth aspect, wherein a support bracket for supporting a radiator is provided to an upper face of the main body.

In the vehicle framework structure of the seventh aspect, the bracket for supporting the radiator is provided to the upper face of the main body. This thereby enables degrees of freedom of design to be raised compared to a structure in which a bracket is provided to the front side member section or the like.

A vehicle framework structure of an eighth aspect is any one of the first aspect to the seventh aspect, wherein bumper reinforcement that extends in the vehicle width direction is attached to front end portions of the shock absorption sections, and a ring shaped structure is formed by the bumper reinforcement, the pair of shock absorption sections, the pair of coupling sections, and the cross member section.

In the vehicle framework structure of the eighth aspect, due to the ring shaped structure being formed by the bumper reinforcement, the pair of shock absorption sections, the pair of coupling sections, and the cross member section, collision load can be distributed effectively by the ring shaped structure.

A vehicle framework structure of a ninth aspect is the eighth aspect, wherein the cross member section couples rear end portions of the coupling sections together.

In the vehicle framework structure of the ninth aspect, the rear end portions of the coupling sections are coupled together by the cross member section and so this enables wide utilization of the space in front of the cross member section.

A vehicle framework structure of a tenth aspect is the eighth aspect, wherein projections that project toward the vehicle rear side are provided to two vehicle width direction end portions of the bumper reinforcement.

In the vehicle framework structure of the tenth aspect, lateral force from the projection to the cross member section can be generated during a small overlap collision, enabling a vehicle to release from the collision object.

A vehicle framework structure of an eleventh aspect is the first aspect, wherein the pair of front side member sections are integrally formed by casting, and the cross member section and the coupling sections are formed by wrought product as a separate member to the front side member section.

In the vehicle framework structure of the eleventh aspect, due to the pair of front side member sections being integrally formed by casting, the number of components can be reduced. Moreover, due to forming the cross member section and the coupling sections from wrought product as separate bodies to the front side member sections, the coupling sections and the cross member section can be suppressed from fracturing along with the front side member section.

As described above, the vehicle framework structure according to the present disclosure is able to distribute collision load effectively.

### BRIEF DESCRIPTION OF THE DRAWINGS

An exemplary embodiment of the present disclosure will be described in detail based on the following figures, wherein:

FIG. 1 is a plan view illustrating relevant parts of a vehicle framework structure according to an exemplary embodiment;

FIG. 2 is a schematic front view of relevant parts of a vehicle framework structure according to an exemplary embodiment, as viewed from a vehicle front side; and

FIG. 3 is a schematic perspective view of relevant parts of a vehicle framework structure according to an exemplary embodiment as viewed from diagonally above.

### DETAILED DESCRIPTION

Description follows regarding a vehicle framework structure according to an exemplary embodiment, with reference to the drawings.

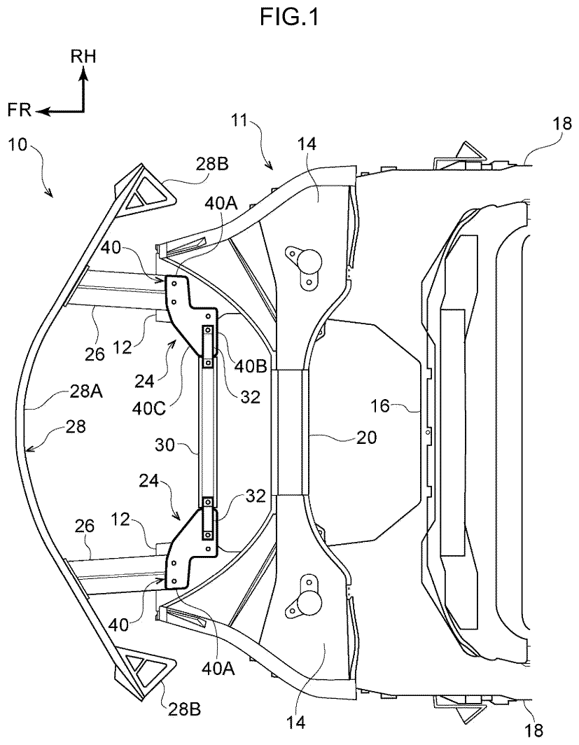

FIG. 1 is a plan view illustrating relevant parts of a vehicle framework structure according to an exemplary embodiment. Note that in each of the drawings arrow FR, arrow UP, arrow RH respectively indicate vehicle forward, vehicle upward, and vehicle rightward directions of a vehicle. Moreover, unless explicitly stated otherwise, references in the following description simply to front and rear, up and down, and left and right directions respectively indicate front and rear in the vehicle front-rear direction, up and down in the vehicle height direction, and left and right in the vehicle left-right direction (vehicle width direction).

As illustrated in FIG. 1, a front framework section 11 integrally formed by casting (die casting) is provided to a front section of a vehicle 10 applied with the vehicle framework structure of the present exemplary embodiment. The front framework section 11 is configured including a left-right pair of front side member sections 12, suspension tower sections 14, a dashboard section 16, and front pillar lower sections 18.

The front side member sections 12 are provided at the two vehicle width direction sides, with each extending along the vehicle front-rear direction. The rear end portions of the front side member sections 12 are also coupled together in the vehicle width direction by the dashboard section 16.

The suspension tower sections 14 are respectively provided between front ends and rear ends of each of the front side member sections 12. A non-illustrated suspension is disposed below each of the suspension tower sections 14.

As an example of the present exemplary embodiment, the left and right suspension tower sections 14 are coupled together in the vehicle width direction by a coupling bar 20, however, there is no limitation thereto, and a configuration may be adopted in which the left and right suspension tower sections 14 are not coupled together.

The front pillar lower sections 18 are provided at the two vehicle width direction end portions of the dashboard section 16. The front pillar lower sections 18 each extend in the vehicle height direction, with a non-illustrated front pillar upper attached to an upper section of each of the front pillar lower sections 18. Moreover, a non-illustrated rocker that extends in the vehicle front-rear direction is coupled to a lower end portion of each of the front pillar lower sections 18.

A crash box 26, serving as a shock absorption section, is provided at the vehicle front side of each of the front side member sections 12, with a coupling bracket 24, serving as a coupling section, interposed therebetween. The crash box 26 is respectively provided at each of the vehicle front sides of the left-right pair of front side member sections 12, and as an example in the present exemplary embodiment, the crash box 26 is formed from sheet steel with a closed cross-section profile.

The crash box 26 extends in the vehicle front-rear direction and plural non-illustrated indentation beads are formed on wall faces of the crash box 26. When collision load is input to the crash box 26 during a head on collision of the vehicle 10, the crash box 26 collapses about the indentation beads and absorbs at least a portion of the collision load. Note that the position and shape of the indentation beads is not particularly limited.

Bumper reinforcement 28 is attached to a front end portion of the crash box 26. The bumper reinforcement 28 extends along the vehicle width direction, and is a framework member having a closed cross-section structure.

The bumper reinforcement 28 is configured including a main body 28A and projections 28B, with the main body 28A having a substantially rounded profile in plan view with a vehicle width direction central portion thereof bulging out toward the vehicle front side.

The projections 28B are respectively provided at two vehicle width direction end portions of the bumper reinforcement 28 so as to project toward the vehicle rear side. The projections 28B are each formed in a substantially triangular shape in plan view, with an apex of each of the triangular shapes oriented toward the vehicle rear and the vehicle width direction inside. This means that during a small overlap collision, in which a collision object collides with a position further to the vehicle width direction outside than the crash box 26 and the front side member section 12, an end portion of the bumper reinforcement 28 folds and bends such that the projection 28B contacts the front side member section 12, in a configuration in which a lateral force along the vehicle width direction is generated on the vehicle 10. In particular, the position where the projection 28B of the bumper reinforcement 28 contacts during a small overlap collision is preferably set to a position corresponding to a coupling bracket 24.

### Coupling Bracket 24

Next, detailed description follows regarding the coupling brackets 24 that are relevant portions of the present disclosure. A left-right pair of the coupling brackets 24 is provided, with each including a main body 40 that extends in the vehicle width direction and the vehicle front-rear direction and is disposed above the front side member section 12. Moreover, the coupling brackets 24 are each formed from wrought product as a separate body to the front framework section 11.

The main body 40 is configured including a first connection section 40A provided at the vehicle width direction outside, and a second connection section 40B provided further to the vehicle rear side and the vehicle width direction inside than the first connection section 40A.

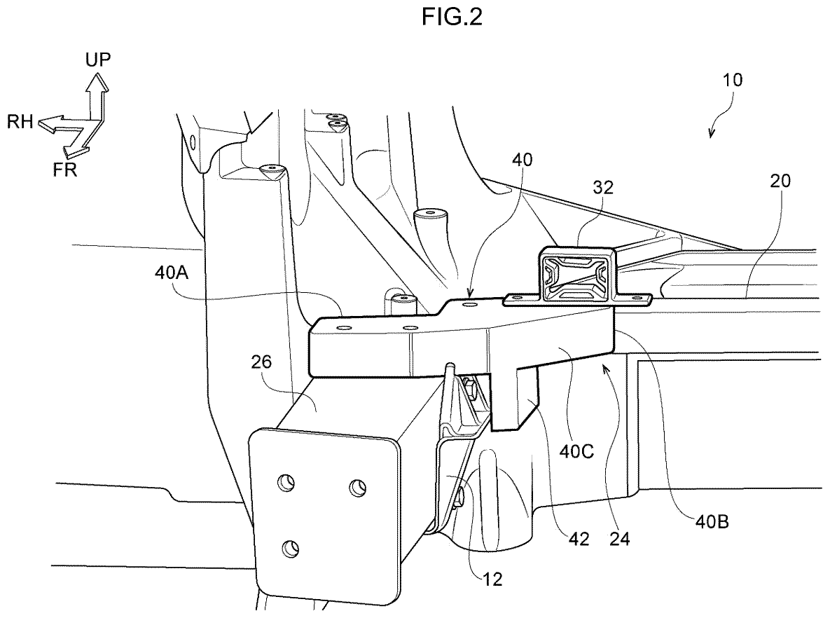

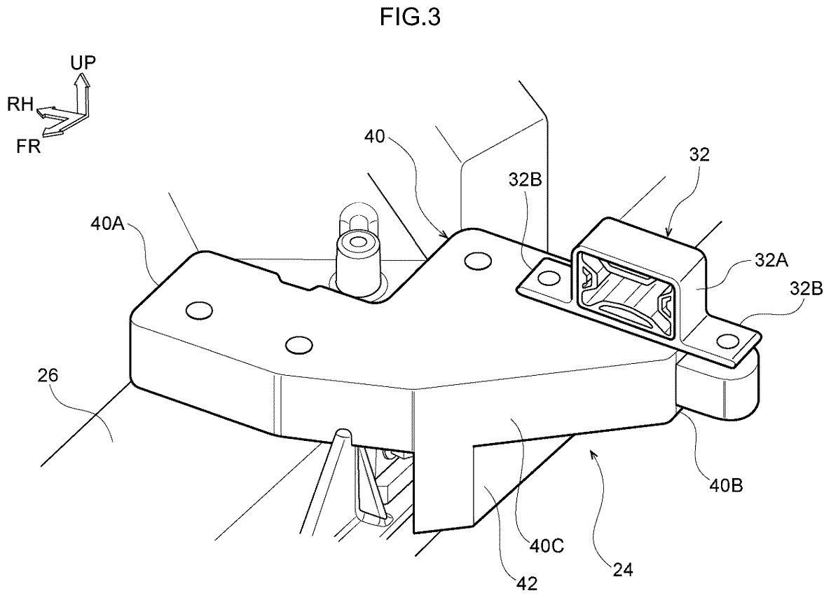

The first connection section 40A is formed in a substantially rectangular shape in plan view, and is disposed above a rear end portion of the crash box 26. Specifically, as illustrated in FIG. 2 and FIG. 3, the first connection section 40A is superimposed on the upper face of the crash box 26, and is fastened to the upper face of the crash box 26 by non-illustrated nuts and bolts. Namely, the crash box 26 is connected to the first connection section 40A of the coupling bracket 24.

As illustrated in FIG. 1, the second connection section 40B is formed in a substantially triangular shape in plan view, with a cross member section 30, described later, connected to the second connection section 40B. Moreover, in the main body 40, an inclined section 40C is provided between the first connection section 40A and the second connection section 40B.

The inclined section 40C is formed to a front portion of the main body 40, and is inclined from a vehicle front toward the vehicle rear and the vehicle width direction inside. This means that the coupling bracket 24 is formed in a shape having a length in the vehicle front-rear direction that becomes shorter on progression from the vehicle width direction outside toward the vehicle width direction inside.

As illustrated in FIG. 2 and FIG. 3, an upright wall 42 extends downward from a lower face of the main body 40. The upright wall 42 extends in the vehicle height direction and the vehicle front-rear direction, and is disposed so as to oppose a portion at the vehicle width direction inside of the respective front side member section 12. The upright wall 42 and the portion at the vehicle width direction inside of the front side member sections 12 may be fastened together.

As illustrated in FIG. 2, a connection section of the front side member section 12 to the crash box 26 is configured in a shape that enables the crash box 26 to be inserted and, for example, is configured with a substantially U-shaped cross-section open on the vehicle upper side. The upright wall 42 of the coupling bracket 24 is disposed at a vehicle width direction inside of the front side member sections 12.

As illustrated in FIG. 3, a support bracket 32 for supporting a non-illustrated radiator is provided on an upper face of the coupling bracket 24. The support bracket 32 is configured including a rectangular frame shaped attachment portion 32A, and a flange portion 32B extending out from the attachment portion 32A toward both the left and right sides.

The attachment portion 32A is provided with plural resiliently deformable bulge portions on the inside, with a radiator being resiliently supported by these bulge portions. Moreover, a gap is provided between the flange portion 32B on the vehicle width direction inside and the second connection section 40B of the main body 40, in a configuration such that the flange portion 32B and the cross member section 30 and the second connection section 40B are jointly fastened together by non-illustrated nuts and bolts in a state in which the cross member section 30 has been inserted into this gap.

As illustrated in FIG. 1, the cross member section 30 is, similarly to the coupling bracket 24, formed from wrought product, and is a member having a closed cross-section structure extending in the vehicle width direction. The cross member section 30 is disposed between the pair of front side member sections 12, and is disposed further to the vehicle rear side than the front end portion of the respective front side member sections 12. More specifically, the cross member section 30 couples the rear end portions of the coupling brackets 24 together.

As illustrated in FIG. 1, a ring shaped structure is formed by the bumper reinforcement 28, the pair of crash boxes 26, the pair of coupling brackets 24, and the cross member section 30.

### Operations

Next, description follows regarding the operation and advantageous effects of the vehicle framework structure according to the present exemplary embodiment.

In the vehicle framework structure according to the present exemplary embodiment, the front side member sections 12 are provided as a pair at the vehicle width direction two sides, with each of the front side member sections 12 extending in the vehicle front-rear direction. Moreover, the crash boxes 26 are provided at the vehicle front side of the front side member sections 12. Furthermore, the cross member section 30 is provided between the front side member sections 12, with the cross member section 30 and the crash boxes 26 being coupled together by the coupling brackets 24. Collision load can accordingly be distributed from the crash boxes 26 to the cross member section 30 through the coupling brackets 24.

Moreover, the coupling brackets 24 are each configured including the first connection section 40A to which the crash box 26 is connected, the second connection section 40B that is further to the vehicle rear side than the first connection section 40A and to which the cross member section 30 is connected, and an inclined section 40C that is disposed between the first connection section 40A and the second connection section 40B and is inclined toward the vehicle width direction inside on progression from the vehicle front toward the vehicle rear. Collision load accordingly readily flows from the inclined section 40C, through the second connection section 40B, to the cross member section 30, enabling collision load to be distributed effectively.

Namely, in a structure in which the inclined section 40C is not provided, most of the collision load input to the crash box 26 would be transmitted toward the vehicle rear side, making it difficult to distribute the collision load, and making it difficult to release collision load to the opposite side to that of a collision. In contrast thereto, in the present exemplary embodiment, collision load from the crash box 26 and the front side member section 12 can be transmitted to the cross member section 30 effectively by the inclined section 40C, enabling distribution of the collision load.

Moreover, in the present exemplary embodiment, the inclined section 40C is formed to a front portion of the coupling bracket 24. This means that collision load can be more effectively transmitted to the inclined section than in cases in which the inclined section 40C is formed to a rear portion of the coupling bracket 24.

Furthermore, in the present exemplary embodiment, collision load is transmitted from a rear end portion of the shock absorption section to the coupling bracket 24 via the first connection section 40A. This means that the entire area of the crash box 26 can be utilized for absorbing collision load. For example, in cases in which the crash box 26 collapses to absorb a crash, due to the first connection section 40A being connected to a rear end portion of the crash box 26, residual non-collapsed portions can be suppressed from being generated in the shock absorption section.

Furthermore, in the present exemplary embodiment, buckling of the cross member section 30 is suppressed compared to a structure in which the cross member section 30 is disposed further forward than the front end portion of the front side member sections 12, enabling good distribution of collision load to be achieved.

Moreover, in the present exemplary embodiment, the main body 40 of each of the coupling brackets 24 is disposed above the respective front side member section 12, and the upright wall 42 of each of the coupling brackets 24 opposes a portion on the vehicle width direction inside of the front side member section 12. This means that each of the coupling brackets 24 is retained by the front side member section 12 in at least two directions, enabling fracturing of the coupling bracket 24 to be suppressed.

Furthermore, in the present exemplary embodiment the upright wall 42 of the coupling bracket 24 and a portion on the vehicle width direction inside of the front side member section 12 are fastened together. Fracturing of the coupling bracket 24 can thereby be further suppressed due to the coupling bracket 24 being fastened to the front side member sections 12.

Furthermore, in the present exemplary embodiment, the support brackets 32 for supporting the radiator are provided to the upper faces of the main bodies 40. This thereby enables the degrees of freedom of design to be raised compared to a structure in which support brackets are provided to the front side member sections 12 or the like.

Furthermore, in the present exemplary embodiment, the ring shaped structure is formed by the bumper reinforcement 28, the crash boxes 26, the coupling brackets 24, and the cross member section 30, and so collision load can be distributed effectively by this ring shaped structure.

Moreover, in the present exemplary embodiment, the cross member section 30 couples the rear ends of the coupling brackets 24 together, enabling wide utilization of space in front of the cross member section 30. Specifically, the space between the cross member section 30 and the bumper reinforcement 28 can be widely utilized.

Furthermore, in the present exemplary embodiment, due to the projections 28B being formed to the two end portions of the bumper reinforcement 28, lateral force from the projections 28B to the cross member section 30 can be generated during a small overlap collision, enabling the vehicle 10 to release from the collision object.

Furthermore, in the present exemplary embodiment, the pair of front side member sections 12 are integrally formed by casting, enabling the number of components to be reduced. Moreover, by forming the coupling brackets 24 and the cross member section 30 from wrought product as a separate body to the front side member sections 12, the coupling brackets 24 and the cross member section 30 can be suppressed from fracturing along with the front side member sections 12.

Although a vehicle framework structure according to the present disclosure has been described above, obviously various embodiments may be implemented within a range not departing from the spirit of the present disclosure. For example, although in the present exemplary embodiment the coupling brackets 24 include the inclined section 40C formed to the front end face of the main body 40, there is no limitation thereto, and an inclined section may be provided at another location. Namely, an inclined section may be provided to a rear end face of the main body 40.

Moreover, although in the present exemplary embodiment the first connection section 40A is connected to a rear end portion of the crash box 26, there is no limitation thereto. For example, the first connection section 40A may be connected to a front-rear direction central portion of the crash box 26. However, from the perspective of eliminating residual non-collapsed portions of the crash box 26, the first connection section 40A is preferably connected to a position in the vicinity of a rear end portion of the crash box 26.

Furthermore although, as illustrated in FIG. 2 and FIG. 3, the coupling bracket 24 is a structure including the upright wall 42 in the present exemplary embodiment, there is no limitation thereto. For example, a coupling bracket may be formed without an upright wall 42 merely by a flat plate shaped main body 40.

Furthermore, although in the present exemplary embodiment the front framework section 11 including the front side member sections 12 is formed by die casting, and the coupling brackets 24 and the cross member section 30 are formed from wrought product, there is no limitation thereto. For example, a configuration may be adopted integrally formed by casting including portions of the front side member sections 12 and the coupling brackets 24. In such cases this would mean that only the cross member section 30 is formed from wrought product as a separate body. Moreover, a configuration may be adopted integrally formed by casting including portions of the coupling brackets 24 and the cross member section 30. Furthermore, a configuration may be adopted with portions of the coupling brackets 24 and the cross member section 30 integrally formed from wrought product.

The following Supplements are disclosed in relation to the above exemplary embodiment.

### Supplement 1

A Vehicle Framework Structure Including:
a pair of front side member sections provided at two vehicle width direction sides and respectively extending in a vehicle front-rear direction;
a pair of shock absorption sections respectively provided at a vehicle front side of the pair of front side member sections;
a cross member section extending in the vehicle width direction and disposed between the pair of front side member sections; and
a left-right pair of coupling sections each configured including a first connection section to which the shock absorption section is connected, a second connection section that is further to a vehicle rear side than the first connection section and to which the cross member section is connected, and an inclined section that is between the first connection section and the second connection section and that is inclined toward the vehicle width direction inside on progression from a vehicle forward direction toward the vehicle rearward direction.

### Supplement 2

The vehicle framework structure of Supplement 1, wherein the inclined section is provided to a front portion of the coupling section.

### Supplement 3

The vehicle framework structure of Supplement 1 or Supplement 2, wherein the first connection section is connected to a rear end portion of the shock absorption section.

### Supplement 4

The vehicle framework structure of any one of Supplement 1 to Supplement 3, wherein the cross member section is disposed further to the vehicle rear side than a front end portion of the front side member section.

### Supplement 5

The vehicle framework structure of any one of Supplement 1 to Supplement 4, wherein the coupling section is configured including a main body that extends in the vehicle width direction and the vehicle front-rear direction and that is disposed above the front side member section, and an upright wall that extends downward from a lower face of the main body and that opposes a portion on a vehicle width direction inside of the front side member section.

### Supplement 6

The vehicle framework structure of Supplement 5, wherein the upright wall is fastened to the portion on the vehicle width direction inside of the front side member section.

### Supplement 7

The vehicle framework structure of Supplement 5, wherein a support bracket for supporting a radiator is provided to an upper face of the main body.

### Supplement 8

The vehicle framework structure of any one of Supplement 1 to Supplement 7, wherein:
bumper reinforcement that extends in the vehicle width direction is attached to front end portions of the shock absorption sections; and
a ring shaped structure is formed by the bumper reinforcement, the pair of shock absorption sections, the pair of coupling sections, and the cross member section.

### Supplement 9

The vehicle framework structure of Supplement 8, wherein the cross member section couples rear end portions of the coupling sections together.

### Supplement 10

The vehicle framework structure of Supplement 8 or Supplement 9, wherein projections that project toward the vehicle rear side are provided to two vehicle width direction end portions of the bumper reinforcement.

### Supplement 11

The vehicle framework structure of any one of Supplement 1 to Supplement 10, wherein:
the pair of front side member sections are integrally formed by casting; and
the cross member section and the coupling sections are formed by wrought product as a separate member to the front side member section.

What is claimed is:

1. A vehicle framework structure comprising:
a pair of front side member sections provided at two vehicle width direction sides and respectively extending in a vehicle front-rear direction;
a pair of shock absorption sections respectively provided at a vehicle front side of the pair of front side member sections;
a cross member section extending in the vehicle width direction and disposed between the pair of front side member sections; and
a left-right pair of coupling sections each configured including a first connection section to which the shock absorption section is connected, a second connection section that is further to a vehicle rear side than the first connection section and to which the cross member section is connected, and an inclined section that is between the first connection section and the second connection section and that is inclined toward the vehicle width direction inside on progression from a vehicle forward direction toward the vehicle rearward direction.

2. The vehicle framework structure of claim 1, wherein the inclined section is provided to a front portion of the coupling section.

3. The vehicle framework structure of claim 1, wherein the first connection section is connected to a rear end portion of the shock absorption section.

4. The vehicle framework structure of claim 1, wherein the cross member section is disposed further to the vehicle rear side than a front end portion of the front side member section.

5. The vehicle framework structure of claim 1, wherein the coupling section is configured including a main body that extends in the vehicle width direction and the vehicle front-rear direction and that is disposed above the front side member section, and an upright wall that extends downward from a lower face of the main body and that opposes a portion on a vehicle width direction inside of the front side member section.

6. The vehicle framework structure of claim 5, wherein the upright wall is fastened to the portion on the vehicle width direction inside of the front side member section.

7. The vehicle framework structure of claim 5, wherein a support bracket for supporting a radiator is provided to an upper face of the main body.

8. The vehicle framework structure of claim 1, wherein:
bumper reinforcement that extends in the vehicle width direction is attached to front end portions of the shock absorption sections; and
a ring shaped structure is formed by the bumper reinforcement, the pair of shock absorption sections, the pair of coupling sections, and the cross member section.

9. The vehicle framework structure of claim 8, wherein the cross member section couples rear end portions of the coupling sections together.

10. The vehicle framework structure of claim 8, wherein projections that project toward the vehicle rear side are provided to two vehicle width direction end portions of the bumper reinforcement.

11. The vehicle framework structure of claim 1, wherein:
the pair of front side member sections are integrally formed by casting; and
the cross member section and the coupling sections are formed by wrought product as a separate member to the front side member section.
